(19) United States
(12) Patent Application Publication
(10) Pub. No.: US 2007/0238513 A1
(43) Pub. Date: Oct. 11, 2007

(54) Game system

(75) Inventor: Akira Osawa, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 11/727,920

(22) Filed: Mar. 29, 2007

(30) Foreign Application Priority Data
Apr. 5, 2006 (JP) 2006-104393

(51) Int. Cl. A63F 13/00

(52) U.S. Cl. 463/20

(57) ABSTRACT

In a game system, a base game, in which when any single combination shown in a payout table is made, a payout corresponding to the combination made is paid out, is independently carried out in each of two or more gaming machines connected to a server via a network. At this time, a character return compulsion process, an establishment compulsion process, a character generation/vanishment process, a character game value awarding process, a game value accumulation process, a game value payout process, a character shift compulsion process and the like are carried out in the respective gaming machines, so that a character game executed among the respective gaming machines is developed to correspond to the progress situation of the base game.

### CROSS REFERENCE TO RELATED APPLICATION

This application is based upon and claims the benefit of priority from the prior Japanese patent Application No. 2006-104393, filed on Apr. 5, 2006.

### BACKGROUND OF THE INVENTION

1. Field of the Invention

The present invention relates to a game system having linked two or more gaming machines.

2. Description of Related Art

In a game system having linked a number of gaming machines such as slot machines, for example, a Japanese Patent Unexamined Publication No. 2004-130119 discloses a system wherein a predetermined ratio of coins bet on each gaming machine is pooled and the pooled coins are at once paid out when a specific winning combination, which has a low probability that it will be established, is made, which is often referred to as a progressive jack pot.

In addition, the system referred to as progressive jack pot includes a system that is independently carried out in each gaming machine, irrespective of whether a number of gaming machines are linked or not.

### SUMMARY OF THE INVENTION

In the above game system, however, since there is little a case where a player pays attention to the other gaming machines linked, except one of the linked gaming machines in which the progressive jack pot is paid out, it is difficult to increase a player's interest in the game (the progressive jack pot, in the case of the game system) that is executed among the gaming machines linked. This is the same for the gaming machine that independently carries out the progressive jack pot.

Accordingly, the present invention has been made to solve the above problem. An object of the present invention is to provide a game system capable of providing a new game that can be developed among respective gaming machines in accordance with the progress situations of games carried out in the respective gaming machines linked, thereby providing a player with a sense of link.

A game system of the present invention is suggested as a game system (for example, game system 100) comprising a server (for example, server 82) and two or more gaming machines (for example, slot machines 1) connected to the server via a network (for example, a network (N)), wherein a game, in which a special benefit is awarded when a predetermined combination is made, is respectively carried out in each of the gaming machines. Each of the gaming machines is provided with a first lottery unit (for example, a main CPU 41, S50) for determining, by lot, whether a character (for example, a character 103) should be generated or vanished, in accordance with a progress situation of a game; a display unit (for example, a lower image display panel 6) for displaying or vanishing the character, based on a lottery result of the first lottery unit; a game value awarding unit (for example, a main CPU 41, S60) for awarding a game value corresponding to the character, in accordance with the progress situation of the game, when the display unit displays the character; a game value accumulation unit (for example, a main CPU 41, S70) for picking up and accumulating the game value awarded by the game value awarding unit, in accordance with the progress situation of the game, when the display unit displays the character; and a game value payout unit (for example, a main CPU 41, S80) for paying out the game value accumulated by the game value accumulation unit, in accordance with the progress situation of the game, when the display unit displays the character.

In the mean time, the server is provided with a second lottery unit (for example, server 82, S104) for determining, by lot, a gaming machine of a shift destination, among the gaming machines connected via the network, to which the character is shifted together with the game value awarded about the character, when there exists a gaming machine wherein the character is displayed in the display unit, irrespective of the game carried out in the gaming machine; and a shift control unit (for example, a server 82, S105) for shifting and displaying the character to the di splay unit of the gaming machine of the shift destination determined based on a lottery result of the second lottery unit and enabling the gaming machine of the shift destination to take over the game value corresponding to the character.

In addition, in the game system (for example, a game system 100), each of the gaming machines (for example, slot machines 1) may be provided with a return compulsion unit (for example, a main CPU 41, S30) for returning and displaying the character (for example, a character 103) generated in the self gaming machine to the display unit (for example, a lower image display panel 6) of the self gaming machine in accordance with the progress situation of the game and taking over the game value corresponding to the character.

Furthermore, in the game system (for example, a game system 100), each of the gaming machines (for example, slot machines 1) may be provided with an establishment compulsion unit (for example, a main CPU 41, S40) for establishing a predetermined combination in the game in progress when the character (for example, character 103) is shifted and displayed to the display unit (for example, a lower image display panel 6) of the self gaming machine.

In addition, in the game system (for example, a game system 100), the server (for example, a server 82) may be one of the gaming machines (for example, slot machines 1) connected via the network (for example, network (N)).

In other words, in the game system of the present invention, each of the gaming machines connected to the server via the network independently carries out a game in which a special benefit is awarded when a predetermined winning is made. At this time, the gaming machine carries out the generation/vanishment of the character, the awarding of the game value corresponding to the character, the picking up and the accumulating of the game value, the payout of the game value accumulated, and the like, in accordance with the progress situation of the game. On the other hand, the sever determines a gaming machine of the shift destination with respect to the characters of the respective gaming machines and the game values awarded about the characters, irrespective of the games carried out in the respective gaming machines, and enables the gaming machine of the shift destination to take over the characters and the game values. Thereby, it is possible to a new game that can be developed among the respective gaming machines in accordance with the progress situations of the games carried out in the respective gaming machines linked, and to provide a player with a sense of link.

### BRIEF DESCRIPTION OF THE DRAWINGS

Other and further objects, features and advantages of the invention will appear more fully from the following description taken in connection with the accompanying drawings in which:

FIG. 1 is a perspective view of an external appearance of a slot machine constituting a game system according to an embodiment of the present invention;

FIG. 2 shows rows of symbols depicted on an outer periphery of each video reel of the slot machine;

FIG. 3 is a block diagram schematically showing a control system of the slot machine;

FIG. 4 is a payout table showing internal winning combinations and establishment possibilities and payouts of the respective combinations of the slot machine;

FIG. 5 shows an example of an image displayed in a lower image display panel of the slot machine;

FIG. 6 shows an example of an image displayed in a lower image display panel of the slot machine;

FIG. 7 shows a structure of a game system according to an embodiment of the present invention;

FIG. 8 is a flow chart of a main control process program in a slot machine constituting a game system according to an embodiment of the present invention;

FIG. 9 is a flow chart of a main game process program in the slot machine;

FIG. 10 is a flow chart of a character link process program in the slot machine;

FIG. 11 is a flow chart of a character return compulsion process program in the slot machine;

FIG. 12 is a flow chart of an establishment compulsion process program in the slot machine;

FIG. 13 is a flow chart of a character generation/changing process program in the slot machine;

FIG. 14 is a flow chart of a character game value awarding process program in the slot machine;

FIG. 15 is a flow chart of a game value accumulation process program in the slot machine;

FIG. 16 is a flow chart of a game value payout process program in the slot machine;

FIG. 17 is a flow chart of a main game process program in a server constituting a game system according to an embodiment of the present invention;

FIG. 18 shows an example of an image displayed in a lower image display panel of a slot machine constituting a game system according to an embodiment of the present invention;

FIG. 19 shows an example of an image displayed in a lower image display panel of the slot machine;

FIG. 20 shows an example of an image displayed in a lower image display panel of the slot machine;

FIG. 21 shows an example of an image displayed in a lower image display panel of the slot machine;

FIG. 22 shows an example of an image displayed in a lower image display panel of the slot machine;

FIG. 23 shows a character table of the slot machine;

FIG. 24 shows a point acquirement table of the slot machine;

FIG. 25 shows a character management table of a server constituting a game system according to an embodiment of the present invention; and

FIG. 26 is a flow chart of a character shift compulsion process program in a slot machine constituting a game system according to an embodiment of the present invention.

### DESCRIPTION OF THE PREFERRED EMBODIMENTS

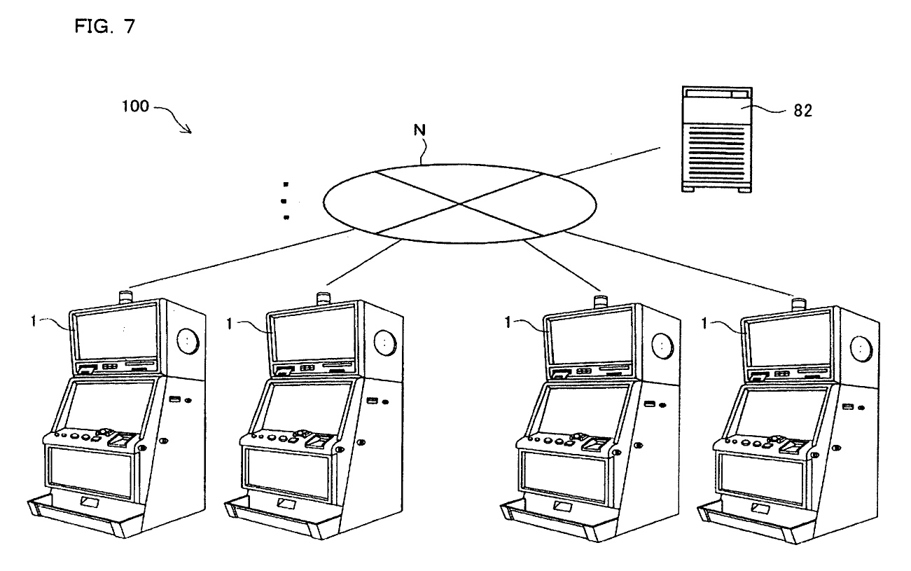

Hereinafter, a game system of the present invention will be described with reference to the accompanying drawings, based on an embodiment that realizes slot machines as each gaming machine constituting the game system. First, a general structure of a game system according to an embodiment is described with reference to FIG. 7. FIG. 7 is a view showing a schematic structure of a game system 100 according to an embodiment. As shown in FIG. 7, in the game system 100 according to this embodiment, a number of slot machines 1 are connected to a server 82 via a network (N).

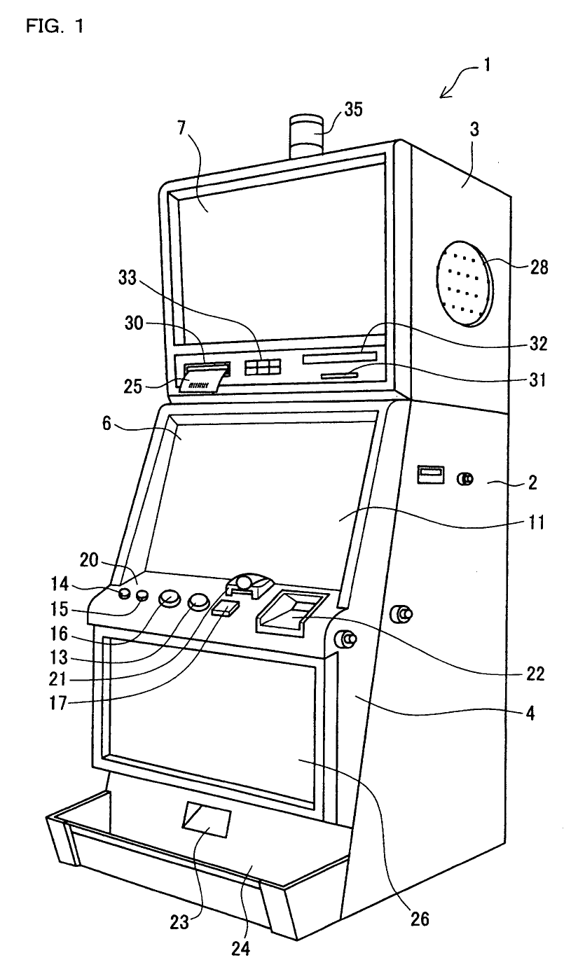

A schematic structure of each slot machine 1 constituting the game system 100 according to this embodiment is described with reference to FIG. 1. FIG. 1 is a perspective view showing an external appearance of a slot machine according to this embodiment.

The slot machine 1 of this embodiment comprises a cabinet 2, a top box 3 provided to an upper part of the cabinet 2 and a main door 4 provided to a front of the cabinet 2.

In addition, an upper image display panel 7 is provided to a front of the top box 3. Herein, the upper image display panel 7 consists of a known transparent liquid crystal panel and displays a demo image and information relating to a game of the slot machine 1, such as game rule, payout table and the like.

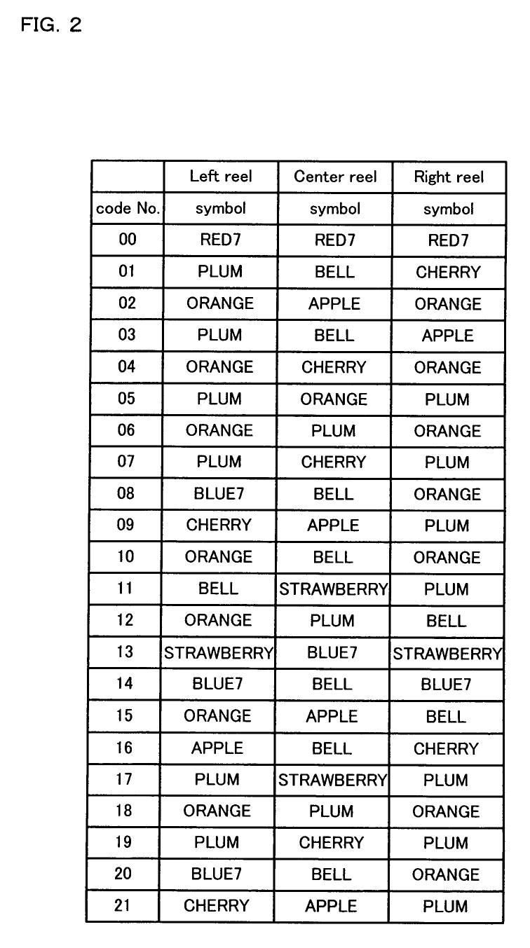

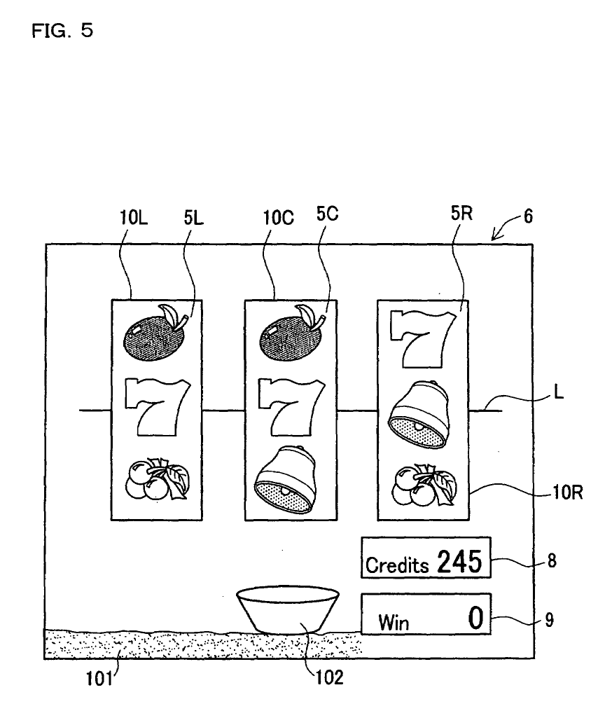

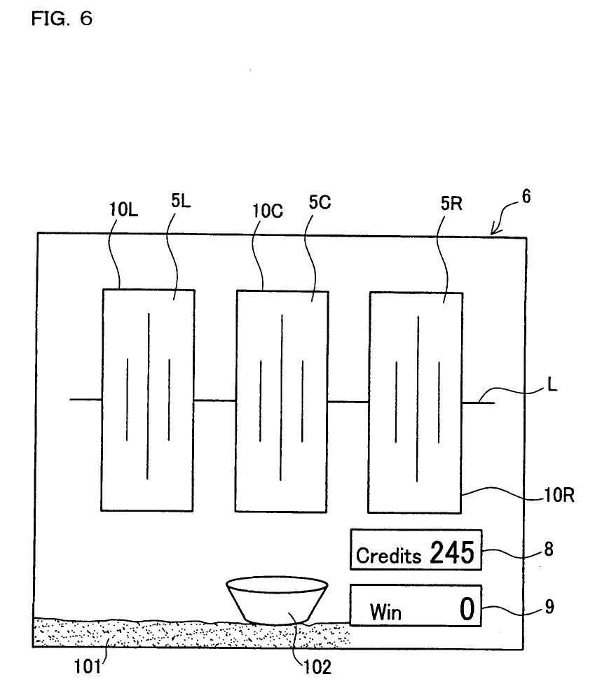

In the mean time, a lower image display panel 6 as a display unit is provided to a front of the main door 4. Herein, an image relating to a game of the slot machine 1 is described which is displayed in the lower image display panel 6. FIGS. 5 and 6 show examples of an image, which are displayed in the lower image display panel 6. In the lower image display panel 6, as shown in FIGS. 5 and 6, symbols depicted on virtual outer peripheries of each of video reels 5L, 5C, 5R are visible from display windows 10L, 10C, 10R during a base game. FIG. 5 shows a stopped state of the symbols depicted on the virtual outer peripheries of the respective video reels 5L, 5C, 5R and FIG. 6 shows a rotating state of the symbols depicted on the virtual outer peripheries of the respective video reels 5L, 5C, 5R. In the mean time, symbols rows (refer to FIG. 2) consisting of 22 symbols (hereinafter, referred to as symbols) are depicted on the virtual outer peripheries of the three video reels 5L, 5C, 5R. In addition, a touch panel 11 (refer to FIG. 1) is provided to a front face of the lower image display panel 6, so that a player can input a variety of instructions through an operation of the touch panel 11 (refer to FIG. 1).

In addition, the lower image display panel 6 is provided with a credit-number display unit 8 and a payout-number display unit 9. The credit-number display unit 8 displays a number of credits that are currently possessed by a player. The payout-number display unit 9 displays a payout amount awarded when a combination of the symbols stopped on a payline L is a predetermined combination, or a payout amount acquired in a bonus game, as a payout-number.

In the mean time, in the lower image display panel 6 shown in FIGS. 5 and 6, a sand beach 101 and an accumulation receptacle 102 are displayed, which will be described later.

As described above, in the lower image display panel 6, the three visible display windows 10L, 10C, 10R are displayed and the three symbols, which are depicted on the virtual outer peripheries of the respective video reels 5L, 5C, 5R, are displayed through the respective display windows 10L, 10C, 10R, respectively. In addition, in the lower image display panel 6, a single payline L is formed which horizontally traverses the three display windows 10L, 10C, 10R. The payline L defines a combination of the symbols. When a combination of the symbols stopped on the payline L is a predetermined combination, a payout amount corresponding to the combination and the credit-number bet (bet-number) is awarded. In the mean time, during a bonus game, a bonus screen, in which the display windows 10L, 10C, 10R (including the video reels 5L, 5C, 5R, too) and the payline L are vanished, is displayed together with the credit-number display unit 8 and the payout-number display unit 9.

Referring back to FIG. 1, a control panel 20 having a number of buttons arranged thereto which enable a player to input instructions relating to a game progress, a coin receiving slot 21 that receives a coin, which is a game medium, into the cabinet 2, and a bill validator 22 are provided below the lower image display panel 6. The control panel 20 is provided with a spin button 13, a change button 14, a cash out button 15, a 1-BET button 16 and a MAX-BET button 17. The spin button 13 is an operating unit for inputting an instruction to start rotations of the video reels 5L, 5C, 5R. The change button 14 is an operating unit that is used when a player asks a staff in the game arcade for exchange of money. The cash out button 15 is an operating unit for inputting an instruction to pay out coins (one credit corresponds to one coin) that correspond to the credit-number possessed by a player into a coin tray 24 from a coin payout slot 23, or an instruction to pay out the coins by a bar coded ticket 25, which will be described later. The 1-BET button 16 is an operating unit for receiving an instruction to bet one credit, among the credits possessed by a player, per one game. The MAX-BET button 17 is an operating unit for receiving an instruction to bet maximum credits (50 credits in this embodiment), among the credits possessed by a player, per one game.

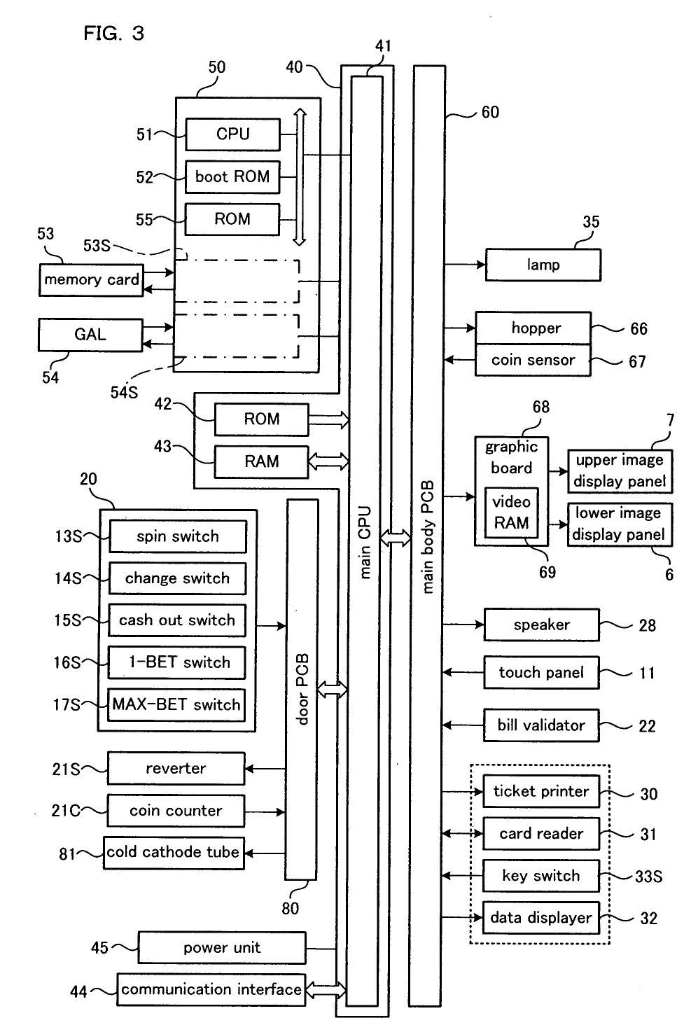

A reverter 21S (refer to FIG. 3) and a coin counter 21C (refer to FIG. 3) are provided in the coin receiving slot 21. The reverter 21S identifies whether a coin inserted into the coin receiving slot 21 is normal or not. A coin except the normal coin is discharged from the coin payout slot 23. In addition, the coin counter 21C (refer to FIG. 3) detects the normal coin received and counts the number thereof.

In addition, the bill validator 22 validates whether bill is normal or not and receives the normal bill into the cabinet 2. The bill inserted into the cabinet 2 is converted into the number of coins and the credits corresponding the converted coin-number are added as credits possessed by a player. In the mean time, the bill validator 22 is adapted to read a bar coded ticket 25, which will be described later. In addition, a belly glass 26 on which a character of the slot machine 1 and the like is drawn is provided to a lower frontal surface of the main door 4, i.e., below the control panel 20.

In the mean time, in the slot machine 1 of this embodiment, a coin, bill or electronic negotiable information (credit) corresponding to the coin or bill is used as a game medium. Meanwhile, the game medium applicable to the invention is not limited thereto. For example, a medal, token, electronic money and ticket can be used.

In addition, a ticket printer 30, a card reader 31, a data displayer 32 and a keypad 33 are provided below the upper image display panel 7. Herein, the ticket printer 30 is a printing device that prints a barcode having data encoded thereto, such as credit-number, date and time, identification number of the slot machine 1 and the like, onto a ticket, thereby outputting the bar coded ticket 25. A player can read the bar coded ticket 25 in another gaming machine to play a game in the gaming machine and can use it for formalities at predetermined places of the game arcade. The card reader 31 reads and writes the data from and into a smart card. The smart card is a card carried by a player, into which data relating to a game history of the player, for example, is stored. The data displayer 32 consists of a fluorescent display and the like, and displays the data read by the card reader 31 and the data inputted by the player through the keypad 33. In addition, the keypad 33 is used to input an instruction or data relating to a ticket issue. Furthermore, a lamp 35 is provided on an upper surface of the top box 3. The lamp 35 is turned on in a predetermined lighting pattern when calling a staff in the game arcade, with respect to a case where an error occurs, for example.

Continuously, the symbols, which are depicted on the virtual outer peripheries of the respective video reels 5L, 5C, 5R and are variably displayed through the display windows 10L, 10C, 10R of the lower image display panel 6 while being scrolled, are described with reference to FIG. 2. FIG. 2 shows rows of symbols depicted on the virtual outer peripheries of the respective video reels 5L, 5C, 5R.

On the virtual outer peripheries of the left video reel 5L, the center video reel 5C and the right video reel 5R are depicted 22 symbols, respectively. Each of the symbol rows consists of a combination of symbols, i.e., “RED 7”, “BLUE 7”, “BELL”, “CHERRY”, “STRAWBERRY”, “PLUM”, “ORANGE”, and “APPLE”. As shown in FIG. 2, on the virtual outer peripheries of the respective video reels 5L, 5C, 5R are depicted predetermined types of symbols, in a predetermined order.

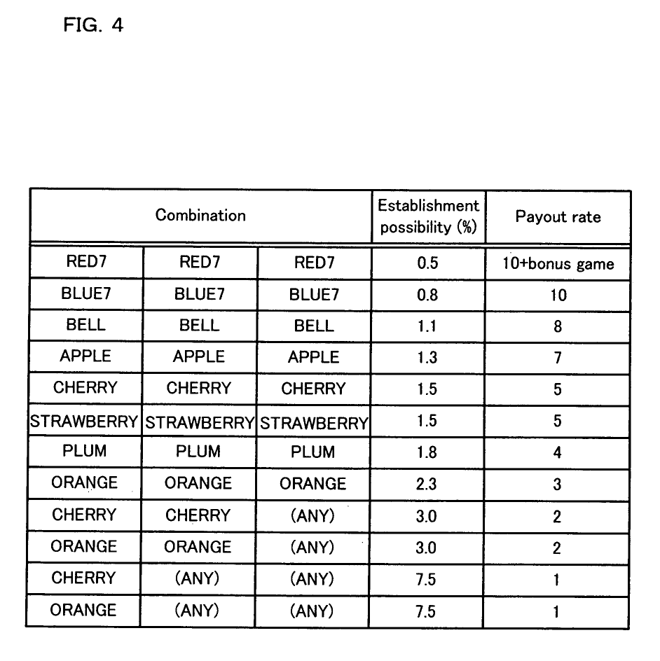

When “BLUE 7”, “CHERRY”, “STRAWBERRY”, “PLUM”, “ORANGE”, and “APPLE” are stopped on the payline L by three, a predetermined payout amount is awarded to a player (refer to FIG. 4). In addition, regarding “CHERRY” and “ORANGE”, even when one or two thereof are stopped on the payline L, a predetermined payout amount corresponding to the number stopped is awarded to a player (refer to FIG. 4).

In addition, when three “RED 7” are stopped on the payline L, a predetermined payout amount is awarded to a player and a game is shifted to a bonus game. Herein, a game executed in the slot machine 1 of the embodiment consists of two game modes, i.e., a base game and a bonus game. In the base game, a game is carried out in which a specific combination of symbols is stopped on the payline L using the video reels 5L, 5C, 5R. In the mean time, in the bonus game, a game is carried out in which three treasure boxes that are selection options are displayed in the lower image display panel 6 and a payout, which corresponds to a treasure box selected by a player from the displayed treasure boxes, is awarded. In the mean time, the description of detailed contents of the bonus game is omitted.

When the spin button 13 is pushed after a bet-number is defined by the operations of the 1-BET button 16 and the MAX-BET button 17, the symbol rows depicted on the virtual outer peripheries of the respective video reels 5L, 5C, 5R, which are shown in FIG. 2, are scroll-displayed downward in the display windows 10L, 10C, 10R as the video reels 5L, 5C, 5R are rotated (refer to FIG. 6). The symbol rows are stopped in the display windows 10L, 10C, 10R as the video reels 5L, 5C, 5R are stopped after a predetermined time elapses (refer to FIG. 5). In addition, since a variety of combinations (predetermined combinations) (refer to FIG. 4) are predetermined based on the combinations of the respective symbols, when a combination of symbols corresponding to the combination is stopped on the payline L, a payout amount corresponding to the stopped combination is awarded to a player, as a special benefit.

In the followings, a structure of a control system of the slot machine 1 of this embodiment is described with reference to FIG. 3. FIG. 3 is a block diagram that schematically shows a control system of the slot machine 1 of this embodiment.

As shown in FIG. 3, the control system of the slot machine 1 basically consists of a motherboard 40 and a gaming board 50. The gaming board 50 is first described. The gaming board 50 comprises a CPU 51, a ROM 55 and a boot ROM 52 that are connected to each other by an internal bus, a card slot 53S corresponding to a memory card 53 and an IC socket 54S corresponding to a GAL (Generic Array Logic) 54.

The memory card 53 consists of a non-volatile memory and is a recording medium that records a game program and a game system program (hereinafter, referred to as game program and the like). The game program recorded in the memory card 53 includes a lottery program. The lottery program is a program for determining symbols (code No. corresponding to the symbols) of the respective reels 5L, 5C, 5R, which are stopped on the payline L. The lottery program includes symbol weighting data corresponding to each of a number of payout rates (for example, 80%, 84% and 88%). The symbol weighting data is data indicating a correspondence relation between the symbol code No. (refer to FIG. 2) for each of the three video reels 5L, 5C, 5R and one or more random number values within a predetermined numerical range (0 to 255). In other words, the code No. of a single symbol corresponds to one or more random number values and a random number is determined by lot, so that a symbol specified with the random number is stopped. In addition, the payout rate is determined on the basis of data for setting a payout rate, which data is outputted from the GAL 54, and a lottery is carried out, based on the symbol weighting data corresponding to the payout rate.

In addition, the card slot 53S is structured to insert and remove the memory card 53 and is connected to the motherboard 40 through an IDE bus. Accordingly, it is possible to change a type or content of a game to be executed in the slot machine 1, by re-recording the game program and the like stored in the memory card 53. In addition, it is also possible to change a type or content of a game to be executed in the slot machine 1, by exchanging a memory card 53 having the other game program and the like recorded therein. In the mean time, the game program includes image data of the symbols depicted on the virtual outer peripheries of the respective video reels 5L, 5C, 5R, image data such as game rule and payout table, and a demo image, in addition to the program relating to the game progress and the image data or sound data that are outputted during the game.

The GAL 54 is a type of a PLD having an OR fix type array structure. The GAL 54 is provided with a number of input and output ports. When data is inputted into the input ports, the GAL 54 outputs data corresponding to the inputted data from the output ports. The data outputted from the output ports is the data for setting a payout rate that has been described above.

In addition, the IC socket 54S is structured to attach and detach the GAL 54 and is connected to the motherboard 40 through a PCI bus. Accordingly, it is possible to change the data for setting a payout rate that is outputted from the GAL 54, by re-recording the GAL 54 or exchanging the GAL 54 itself.

The CPU 51, the ROM 55 and the boot ROM 52, which are connected to each other by the internal bus, are connected to the motherboard 40 through the PCI bus. The PCI bus carries out a signal transfer between the motherboard 40 and the gaming board 50 and supplies power to the gaming board 50 from the motherboard 40. The ROM 55 stores nation identification information and an authentication program. The boot ROM 52 stores a preliminary authentication program and a program (boot code) enabling the CPU 51 to execute the preliminary authentication program.

The authentication program is a program (falsification check program) for authenticating the game program and the like. The authentication program is described in accordance with a falsification check procedure for the game program and the like that are objects of an authentication process. The preliminary authentication program is a program for authenticating the authentication program and is described in accordance with a falsification check procedure for the authentication program that is an object of the authentication process.

Continuously, the motherboard 40 is described. The motherboard 40 is structured with a universal motherboard (printed circuit board having basic parts of a personal computer mounted thereon) and comprises a main CPU 41 as a processor, a ROM 42, a RAM 43 and a communication interface 44.

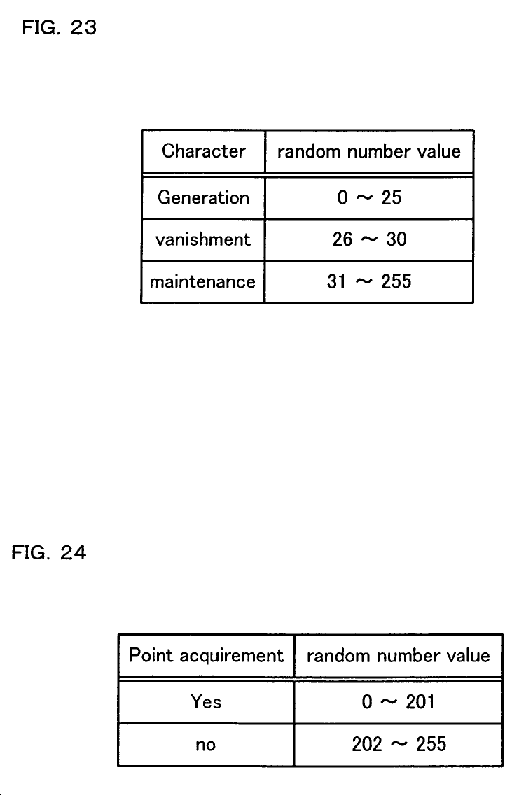

The ROM 42 consists of a memory device such as flash memory, and stores a program such as BIOS executed by the main CPU 41, and permanent data such as a lottery table of the base game and bonus game, a payout table (refer to FIG. 4), a character table (refer to FIG. 23), a point acquirement table (refer to FIG. 24) and the like. When the BIOS is executed by the main CPU 41, each of peripheral devices is initialized and an import process of the game program and the like stored in the memory card 53 is carried out through the gaming board 50.

The RAM 43 stores the data and program that is used when the CPU 41 operates. In addition, the RAM 43 can store a variety of programs such as authentication program and game program that are read through the gaming board 50, and a variety of information such as credit-number that are currently possessed by a player.

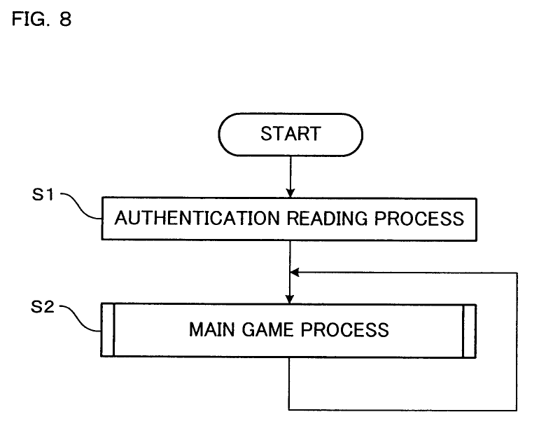

In addition, the communication interface 44 is provided to communicate with a server 82 or the other slot machines 1 (refer to FIG. 7) that are provided in or outside the game arcade, through the network (N) that is a communication line. The slot machine 1 communicates bet information in a main game process (refer to S2 in FIG. 8), a lottery result in a bass game lottery process, a result in a character link process and the like with the server 82 or the other slot machines 1.

In addition, a main body PCB 60 and a door PCB 80 are respectively connected to the motherboard 40 via a USB. Furthermore, the motherboard 40 is connected with a power unit 45. When power is supplied to the motherboard 40 from the power unit 45, the main CPU 41 of the motherboard 40 starts to operate. In addition, the power is supplied to the gaming board 50 via the PCI bus, so that the CPU 51 starts to operate.

The main body PCB 60 and the door PCB 80 are connected with a device or apparatus for producing an input signal that will be inputted to the main CPU 41, and a device or apparatus that is controlled by a control signal outputted from the main CPU 41. The main CPU 41 executes the game program and the like stored in the RAM 43, based on the input signal inputted to the main CPU 41. Then, the main CPU 41 carries out an arithmetic process, thereby storing a result thereof in the RAM 43 or controlling each device or apparatus.

The main body PCB 60 is connected with a lamp 35, a hopper 66, a coin sensor 67, a graphic board 68, a speaker 28 (refer to FIG. 1), a touch panel 11, a bill validator 22, a ticket printer 30, a card reader 31, a key switch 33S and a data displayer 32.

Herein, the touch panel 11 is disposed at a front face of the lower image display panel 6, specifies a coordinates position of a part that is touched by a player and can determine where a player touches and which direction the touched part is moved, based on the specified coordinates position information.

The hopper 66 is mounted in the cabinet 2 and pays out predetermined number of coins to the coin tray 24 from the coin payout slot 23, based on a control signal outputted from the main CPU 41. The coin sensor 67 is arranged in the coin payout slot 23 and outputs an input signal to the main CPU 41 when it detects that the predetermined number of coins are paid out from the coin payout slot 23.

The graphic board 68 controls an image display in the upper image display panel 7 and the lower image display panel 6, based on the control signal outputted from the main CPU 41. For example, the credit-number possessed by a player, which is stored in the RAM 43, is displayed in the credit-number display unit 8. In addition, the payout-number of the credits by payout is displayed in the payout-number display unit 9. Herein, the graphic board 68 is provided with a VDP (Video Display Processor) for producing image data on the basis of a control signal outputted from the main CPU 41, a video RAM 69 for temporarily storing the image data produced by the VDP, and the like. In the mean time, the image data that is used for producing the image data by the VDP is included in the game program. In addition, the graphic board 68 also carries out the display control of the rotation and stopping of the video reels 5L, 5C, 5R in the lower image display panel 6 (refer to FIGS. 6 and 7), based on a control signal outputted from the main CPU 41.

Furthermore, the bill validator 22 validates whether the bill and the bar coded ticket 25 are normal or not and accommodates the normal bill and the normal bar coded ticket 25 in the cabinet 2. In accommodating the normal bill, the bill validator 22 outputs an input signal to the main CPU 41, based on an amount of the bill. In addition, the bill validator 22 outputs an input signal to the main CPU 41, based on the number of coins that are recorded in the normal bar coded ticket 25.

The ticket printer 30 prints a barcode having data encoded thereto, such as credit-number stored in the RAM 43, on a ticket, based on a control signal outputted from the main CPU 41, thereby outputting the bar coded ticket 25. In addition, the card reader 31 reads the data from the smart card to transmit it to the main CPU 41, and writes the data into the smart card, based on a control signal outputted from the main CPU 41. The key switch 33S is provided to the keypad 33, and outputs an input signal to the main CPU 41 when a player manipulates the keypad 33. The data displayer 32 displays the data read by the card reader 31 or the data that the player inputs through the keypad 33, based on a control signal outputted from the main CPU 41.

In the mean time, the door PCB 80 is connected with the control panel 20, the reverter 21S, the coin counter 21C and a cold cathode tube 81. The control panel 20 is provided with a spin switch 13S corresponding to the spin button 13, a change switch 14S corresponding to the change button 14, a cash out switch 15S corresponding to the cash out button 15, a 1-BET switch 16S corresponding to the 1-BET button 16 and a MAX-BET switch 17S corresponding to the MAX-BET button 17. Each of the switches 13S to 17S outputs an input signal to the main CPU 41 when each of the corresponding buttons 13 to 17 is pushed by a player.

The coin counter 21C is provided in the coin receiving slot 21 and validates whether a coin, which is inserted in the coin receiving slot 21 by the player, is normal or not. The coin counter 21C discharges a coin except the normal coin from the coin payout slot 23 and outputs an input signal to the main CPU 41 when it detects a normal coin.

The reverter 21S is operated based on a control signal outputted from the main CPU 41 and distributes the coin, which is validated as a normal coin by the coin counter 21C, to a cash box (not shown) or the hopper 66 mounted in the slot machine 1. The cold cathode tube 81 is provided at the rear sides of the lower image display panel 6 and the upper image display panel 7, is turned on based on a control signal outputted from the main CPU 41 and serves as a backlight.

In the followings, an internal winning combination and a payout thereof, which are determined when a game is carried out using the video reels 5L, 5C, 5R in the slot machine 1 of this embodiment, are described with reference to FIG. 4. FIG. 4 is a payout table showing internal winning combinations and establishment possibilities and payouts of the respective combinations when a game is carried out using the video reels 5L, 5C, 5R. Herein, the payouts shown in FIG. 4 indicate payouts when a bet-number is “1”. Accordingly, when a bet-number is “1”, the payout values shown in FIG. 4 are added to the credits. When a bet-number is “2” or more, values obtained by multiplying the payout values shown in FIG. 4 by the bet-number are added to the credits.

In addition, the establishment possibilities shown in FIG. 4 indicate that a payout rate in a game except the bonus game is 88%. Meanwhile, the establishment possibilities indicate that a combination will be made when code Nos. of the respective video reels 5L, 5C, 5R are determined based on the three random number values by referring to the symbol weighting data. In other words, the respective combinations are made to correspond to the random number values.

For example, an establishment possibility of a bonus game trigger is 0.5%. When a bonus game trigger is determined by lot, three “RED 7” symbols are stopped on the payline, so that 10 credits are paid out as payout and a bonus game is generated.

In addition, an establishment of “BLUE 7” is 0.8%. When this combination is made, three “BLUE 7” symbols are stopped on the payline and 10 credits per one bet are paid out as payout. Furthermore, an establishment possibility of “BELL” is 1.1%. When this combination is made, three “BELL” symbols are stopped on the payline and 8 credits per one bet are paid out as payout. Likewise, the establishment possibilities and payout-numbers are set for each combination shown in FIG. 4. When a combination of symbols, which is not included in the combinations shown in FIG. 4, is stopped, it means a losing. As a result, the credit is not paid out.

Continuously, a main control program that is executed in the respective slot machines 1 of this embodiment is described with reference to the drawings. FIG. 8 is a flow chart of a main control program. In the mean time, it is assumed that each of the slot machines 1 has the memory card 53 inserted in the card slot 53S and the GAL 54 is thus attached to the IC socket 54S.

First, when a power switch is on (power is supplied) in the power unit 45, the motherboard 40 and the gaming board 50 start to operate, respectively, so that an authentication reading process of a step (hereinafter, abbreviated as ‘S’) 1 is carried out. In the authentication reading process, the motherboard 40 and the gaming board 50 execute separate processes at the same time, respectively. In other words, in the gaming board 50, the CPU 51 reads out the preliminary authentication program stored in the boot ROM 52 and carries out, in advance, a preliminary authentication process of confirming and validating whether the authentication program is not falsified, in accordance with the read preliminary authentication program, before the loading to the motherboard 40. In the mean time, in the motherboard 40, the main CPU 41 executes the BIOS stored in the ROM 42, develops the compressed data stored in the BIOS to the RAM 43, executes the BIOS developed to the RAM 43 and diagnoses and initializes the peripheral devices.

After that, the main CPU 41 reads out the authentication program stored in the ROM 55 and carries out an authentication process of confirming and validating whether the game program and the like stored in the memory card 53 inserted in the card slot 53S are not falsified. When the authentication process is normally ended, the main CPU 41 writes the authenticated game program and the like in the RAM 43 and acquires the data for setting a payout rate and the nation identification information. After carrying out the above processes, the main CPU 41 ends the authentication reading process.

Then, in a S2, the main CPU 41 sequentially reads out and executes the game program and the like from the RAM 43, which are authenticated in the authentication reading process of the S1, and carries out a main game process. By carrying out this main game process, a game is executed in the slot machine 1 of this embodiment. The main game process is repeatedly carried out while the power is being supplied to the slot machine 1.

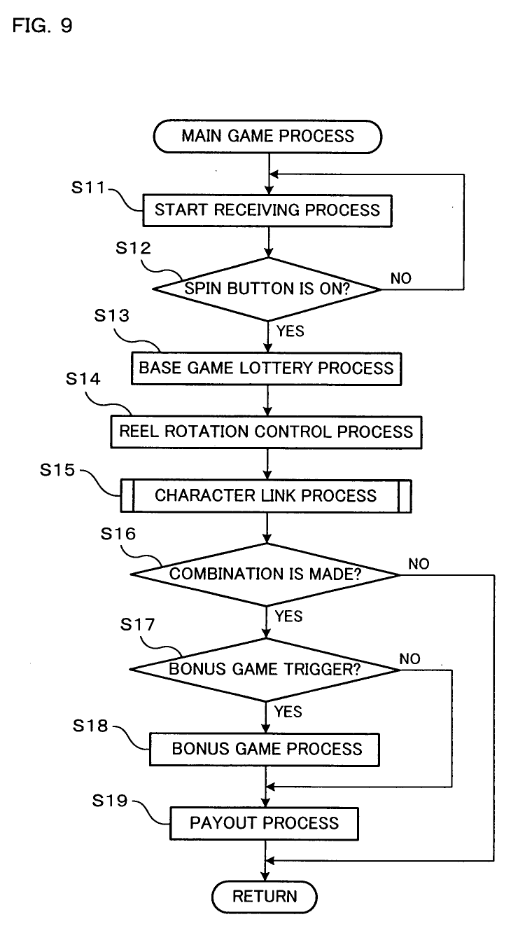

Next, a sub process of the main game process in the S2 is described with reference to FIG. 9. FIG. 9 is a flow chart of a main game process program in the slot machine 1 of this embodiment. In the mean time, the respective programs shown in the flow chart of FIG. 9 are stored in the ROM 42 or RAM 43 provided to the slot machine 1 and are executed by the main CPU 41.

First, as shown in FIG. 9, in a S11, the main CPU 41 carries out a start receiving process of setting the coin insertion or the bet-number on the payline L, after executing an initial setting. At this time, in the start receiving process, the coin insertion or the bet operations using the 1-BET button 16 and the MAX-BET button 17 by a player are carried out.

In a S12, the main CPU 41 determines whether the spin button 13 is pushed or not. The determination of whether the spin button 13 is pushed is carried out, based on whether an input signal is received from the spin switch 13S. When the spin button 13 is not pushed (S12, NO), the main process returns to the start receiving process (S11). At this time, an operation of changing the bet-number and like can be made. In the mean time, when the spin button 13 is pushed (S12, YES), the bet-number set on the payline L is subtracted from the credit-number possessed by a player, based on the operations of the 1-BET button 16 and the MAX-BET button 17, which is then stored in the RAM 43 as the bet information.

Then, after a S13, the main CPU 41 carries out a base game process using the video reels 5L, 5C, 5R.

First, in a S13, the main CPU 41 carries out a lottery process of a base game. Specifically, the main CPU 41 executes the program for producing a random number, which is included in the lottery program stored in the RAM 43, thereby selecting random number values corresponding to the three video reels 5L, 5C, 5R, from the numerical range of “0 to 255”. Then, the main CPU 41 refers to the symbol weighting data corresponding to the data for setting a payout rate, thereby determining the code Nos. (refer to FIG. 2) of the respective video reels 5L, 5C, 5R, based on the three random number values selected. Then, the main CPU 41 stores the determined code Nos. of the respective video reels 5L, 5C, 5R in the RAM 43 and then proceeds to a S14. Herein, since the code Nos. of the respective video reels 5L, 5C, 5R correspond to the code Nos. of symbols to be stopped on the payline L, the main CPU 41 determines the code Nos. of the respective video reels 5L, 5C, 5R, so that a combination in a game is determined. For example, when it determines the code Nos. of the respective video reels 5L, 5C, 5R as “00”, “00” and “00”, the main CPU 41 determines a combination as “RED 7”. Like this, the code Nos. of the respective video reels 5L, 5C, 5R are determined, so that a lottery relating to the typical combinations (refer to FIG. 4) is carried out.

Next, in the S14, the main CPU 41 carries out a reel rotation control process. The reel rotation control process is a process of stopping the rotations of the respective video reels 5L, 5C, 5R so that a combination of symbols determined in the base game lottery process (S13) is stopped on the payline L, after all the video reels 5L, 5C, 5R are rotated. In the mean time, this process is a process carried out between the main CPU 41 and the graphic board 68.

Specifically, in the reel rotation control process (S14), the main CPU 41 first transmits to the graphic board 68 a start signal for starting the rotations of the video reels. When the graphic board 68 receives the start signal, it carries out a video reel rotation display process. In other words, the graphic board 68 carries out a display control for starting the rotations of the respective video reels 5L, 5C, 5R in the lower image display panel 6. Then, after transmitting the start signal, the main CPU 41 determines an effect aspect (for example, image display in the upper image display panel 7 or sound output from the speaker 28) for a single game and starts an effect with the determined effect pattern. After that, when a predetermined stop timing for stopping the rotations of the video reels 5L, 5C, 5R has come, the main CPU 41 transmits the video reel code Nos. stored in the RAM 43 to the graphic board 68. The graphic board 68 carries out a video reel stopping display process. Thereby, the symbols corresponding to the lottery result are stopped on the payline L of the respective display windows 10L, 10C, 10R in the lower image display panel 6.

Then, in a S15, the main CPU 41 carries out a character link process and then proceeds to a S16. In the mean time, the character link process of the S15 will be described later.

Continuously, in the S16, the main CPU 41 determines whether a combination having a payout is made or not. As a result, when one of the combinations shown in FIG. 4 is made (S16, YES), the main CPU 41 proceeds to a S17. In the mean time, when no combination is made (S16, NO), the main CPU 41 re-executes this program.

In the S17, the main CPU 41 determines whether a bonus game trigger is made in a base game. Specifically, when using the payout table of FIG. 4, the main CPU 41 determines that a bonus game trigger is made when a symbol combination of “RED 7” is stopped on the payline L.

When it is determined that a bonus game trigger is made (S17, YES), the main CPU 41 carries out a selective bonus game process in a S18. In the mean time, the detailed description of the bonus game process is omitted. After that, the main CPU 41 pays out the payouts, which are respectively acquired in the base game and the bonus game, to the player (S19). At this time, it is possible to pay out the payouts as coins (1 credit corresponds to 1 coin) relating to the credit-number by pushing the cash out button 15, and to pay out the payouts by the bar coded ticket 25.

In the mean time, when it is determined that a bonus game trigger is not made (S17, NO), the main CPU 41 pays out the payouts (refer to FIG. 4) acquired in the base game to the player (S19). After that, the main CPU 41 re-executes this program.

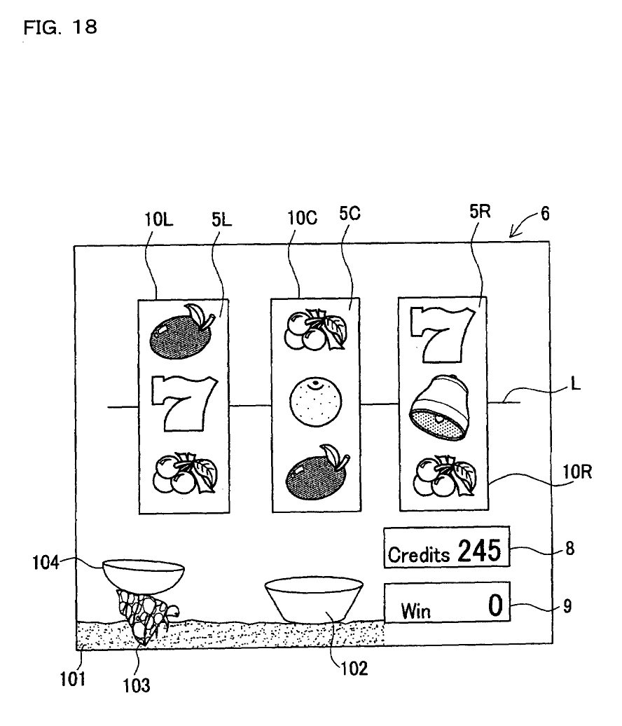

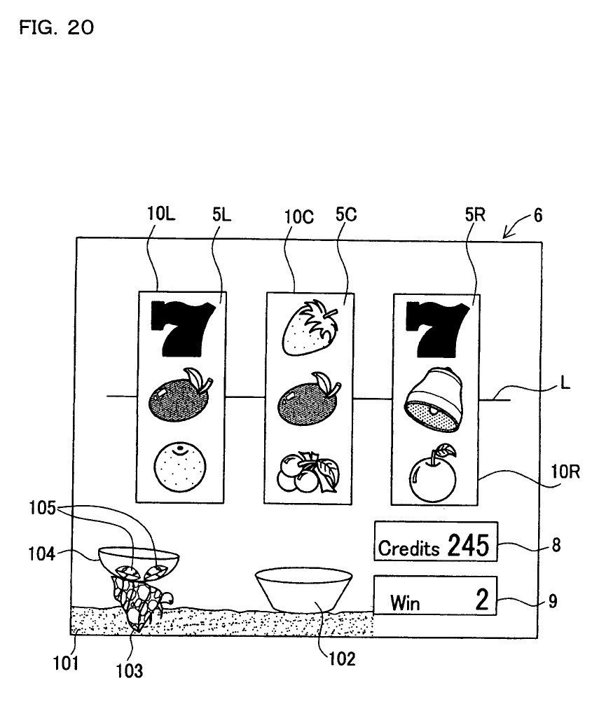

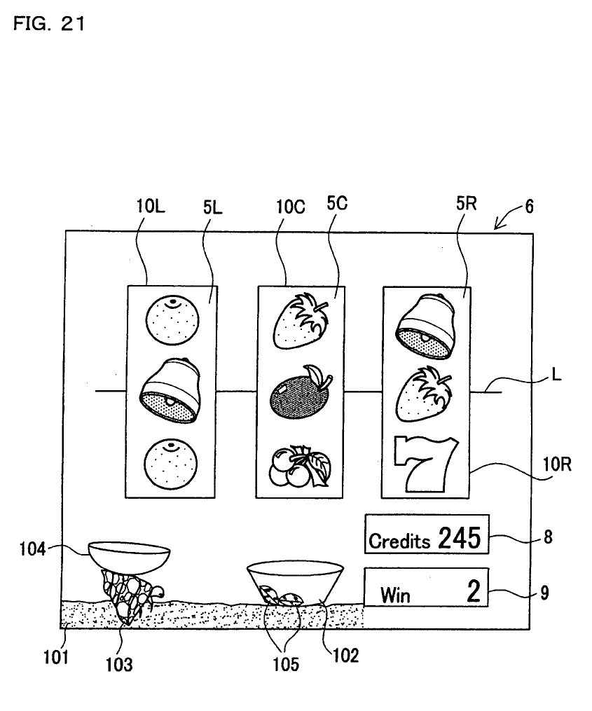

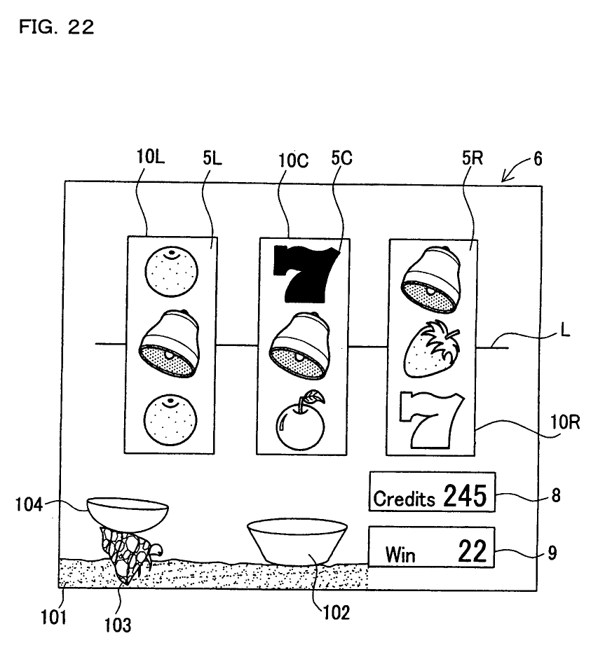

Next, a character game is described which is carried out between the respective slot machines 1 of the game system 100 according to this embodiment. In each of the slot machines 1, when a base game is carried out, the sand beach 101 and the accumulation receptacle 102 are displayed in the lower image display panel 6, as shown in FIGS. 5 and 6. When a condition is satisfied in a base game, it is displayed in the lower image display panel 6 that a character (hermit crab) 103 emerges from the sand beach 101 while carrying an awarding receptacle 104, so that the character (hermit crab) 103 is generated, as shown in FIG. 18, for example. After that, when a condition is satisfied in a new base game, it is displayed in the lower image display panel 6 that the character (hermit crab) 103 finds out a predetermined number of points (clams) 105 from the sand beach 101 and puts the points in the own awarding receptacle 104, as shown in FIG. 20, for example. After that, when a condition is satisfied in a new base game, it is displayed in the lower image display panel 6 that the character (hermit crab) 103 moves all the points (clams) 105 to the accumulation receptacle 102 from the own awarding receptacle 104, as shown in FIG. 21, for example. After that, when a condition is satisfied in a new base game, the payout-number of “10” per one of all the points (clams) 105 moved to the accumulation receptacle 102 is addition-displayed as game values in the payout-number display unit 9, and an image that all the points (calms) 105 are removed from the accumulation receptacle 102 in exchange of the addition display is displayed in the lower image display panel 6, as shown in FIG. 22, for example.

In addition, the server 82 can shift and display the character (hermit crab) 103, which is displayed in the lower image display panel 6 of each slot machine 1, to the lower image display panels 6 of the other slot machines 1, together with the awarding receptacle 104 thereof and the point (clam) 105 put in the receptacle, irrespective of the situation of the base game in each slot machine 1. On the other hand, when a condition is satisfied in the base games of the respective slot machines 1, each of the slot machines can shift and display the characters (hermit crabs) 103 generated in the self slot machine to the lower image display panel 6 of the self slot machine from the lower image display panels 6 of the other slot machines 1, together with the awarding receptacle 104 thereof and the points (clams) 105 put in the receptacle. Further, in this case, a combination is made in the base game. In the mean time, in the respective slot machines 1, when a condition is satisfied in a base game, it is displayed in the lower image display panel 6 that the character (hermit crab) 103 is immersed in the sand beach 101 together with the own awarding receptacle 104 and the point (clam) 105 put in therein, so that the character (hermit crab) 103 may be vanished.

In the mean time, the image data of the character game that is exemplified in FIGS. 18 to 22 is included in the game program of the memory card 53.

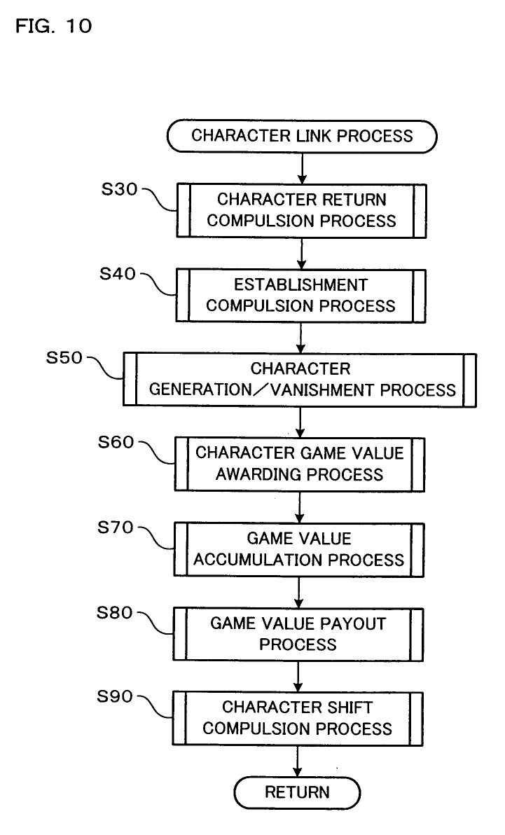

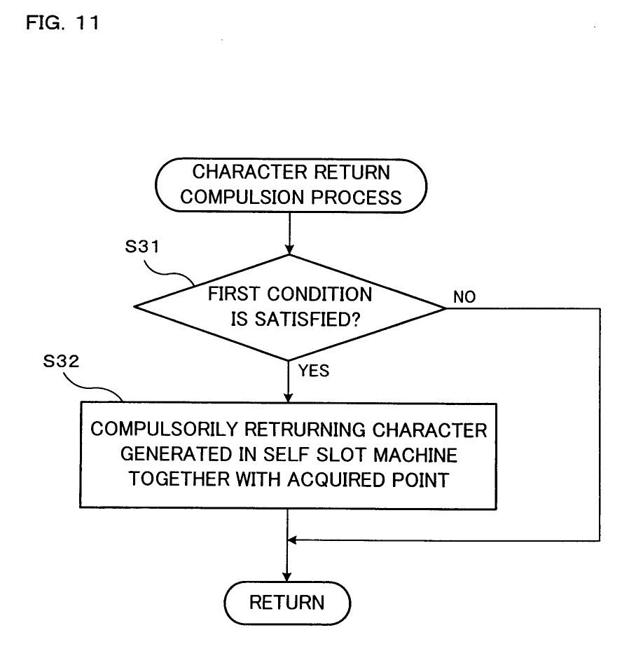

The character game is executed when the character link process of the S15 is carried out in each slot machine 1. Accordingly, a sub process of the character link process in the S15 is described with reference to FIG. 10. FIG. 10 is a flow chart of a character link process program in the slot machine 1 of this embodiment. In the mean time, each program shown in the flow chart of FIG. 10 is stored in the ROM 42 or RAM 43 provided to each slot machine 1 and is executed by the main CPU 41. This is the same for the respective programs shown in flow charts of FIGS. 11 to 16 and FIG. 26.

The main CPU 41 of each slot machine 1 carries out a character return compulsion process of a S30, as shown in FIG. 10. Further, the main CPU 41 of each slot machine 1 sequentially carries out an establishment compulsion process of a S40, a character generation/vanishment process of a S50, a character game value awarding process of a S60, a game value accumulation process of a S70, a game value payout process of a S80 and a character shift compulsion process of a S90.

FIG. 11 is a flow chart of a character return compulsion process program of the S30. When the main CPU 41 executes a character return compulsion process of the S30, it first determines whether a first condition is satisfied in the base game, in a S31. Herein, the first condition may include a case where, among the symbols stopped on the payline L, the symbol of “ORANGE” is displayed in the display window 10C only, as shown in FIG. 18. Herein, when the first condition is satisfied in the base game (S31, YES), the main CPU 41 proceeds to a S32, displays the character (hermit crab) 103 emerging from the sand beach 101, which is generated in the self slot machine but is displayed in the other slot machine, in the lower image display panel 6 of the self slot machine, together with the point (clam) 105 put in the awarding receptacle 104, and notifies the other slot machines 1 of the fact. At this time, the main CPU 41 of the other slot machine having the fact notified vanishes the character (hermit crab) 103 from the lower image display panel 6 of the other slot machine, as an image that is immersed in the sand beach 101 together with the point (clam) 105 put in the awarding receptacle 104.

Herein, to specify the other slot machine that currently displays the character (hermit crab) 103 generated in the self slot machine is carried out by the communication with the server 82 having notified the signal of the fact through the communication interface 44. Thereby, the slot machine shifts (compulsorily returns) and displays the character (hermit crab) 103, which is generated in the self slot machine but is currently displayed in the other slot machine, to the lower image display panel 6 of the self slot machine from the lower image display panel 6 of the other slot machine 1. In the mean time, when there are a number of characters (hermit crabs) 103, which are generated in the self slot machine but are currently displayed in the other slot machine, all of the characters are objects of the compulsion return display. At this time, some of the characters may be specified by lot. However, when there is no character (hermit crab) 103 that is generated in the self slot machine, the compulsion return display is not carried out. After that, the main CPU 41 proceeds to an establishment compulsion process of a S40 in FIG. 10, including a case where the first condition is not satisfied (S31, NO) in the base game.

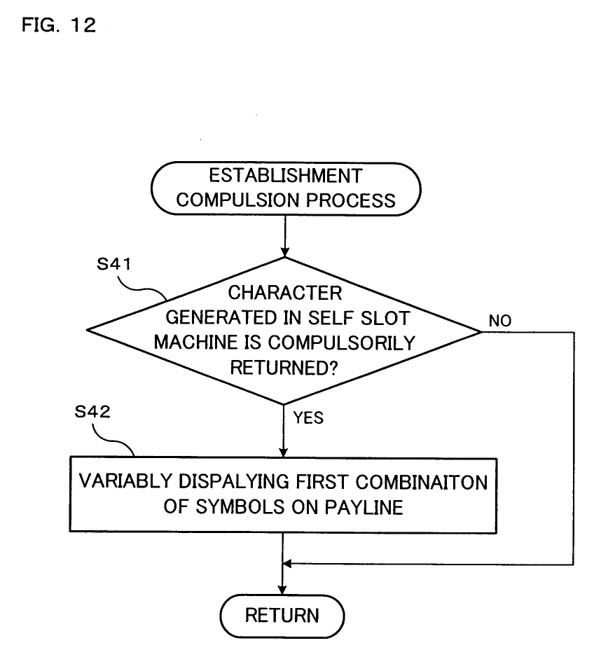

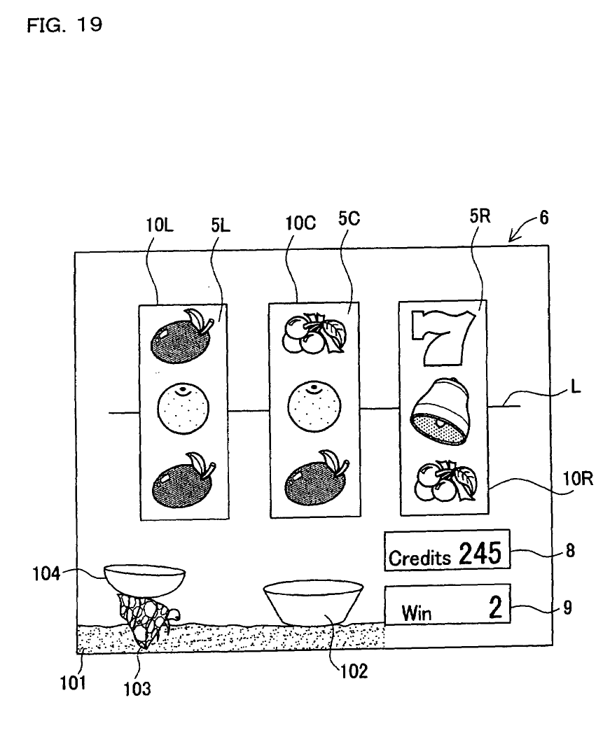

FIG. 12 is a flow chart of an establishment compulsion process of the S40. When the main CPU 41 executes the establishment compulsion process of the S40, it determines whether the character (hermit crab) 103 that is generated in the self slot machine is compulsorily returned or not. This determination is as follows: when the character (hermit crab) 103, which is generated in the self slot machine as the S32 is executed, is actually shifted, it is considered that the character (hermit crab) 103 that is generated in the self slot machine is compulsorily returned. When the character (hermit crab) 103 that is generated in the self slot machine is compulsorily returned (S41, YES), the main CPU 41 proceeds to a S42, variably displays the symbols in at least one of the display windows 10L, 10C, 10R so as to variably stop a first combination of symbols on the payline L and stops a combination of symbols constituting the first combination on the payline L. Herein, the first combination may include a case where two “ORANGE” symbols are stopped on the payline L, as shown in FIG. 19, for example. Accordingly, when the first condition of the S31 is as shown in FIG. 18, i.e., when the symbol of “ORANGE” among the symbols stopped on the payline L is displayed in the display window 10C only, only the symbols of the display window 10L are variably displayed in the S42, thereby stopping the symbol of “ORANGE” on the payline L of the display window 10L. However, after the respective symbols of the display windows (10L, 10C) or display windows (10L, 10C, 10R) are variably displayed, two “ORANGE” symbols may be stopped on the payline L, as shown in FIG. 19. Then, the payout of “2” (refer to FIG. 4), which corresponds to the combination in which the two “ORANGE” symbols are stopped on the payline L, is displayed in the payout-number display unit 9 (refer to FIG. 19). After that, the main CPU 41 proceeds to a character generation/vanishment process of a S50 in FIG. 10, including a case where the character (hermit crab) 103, which is generated in the self slot machine, is not compulsorily returned (S41, NO).

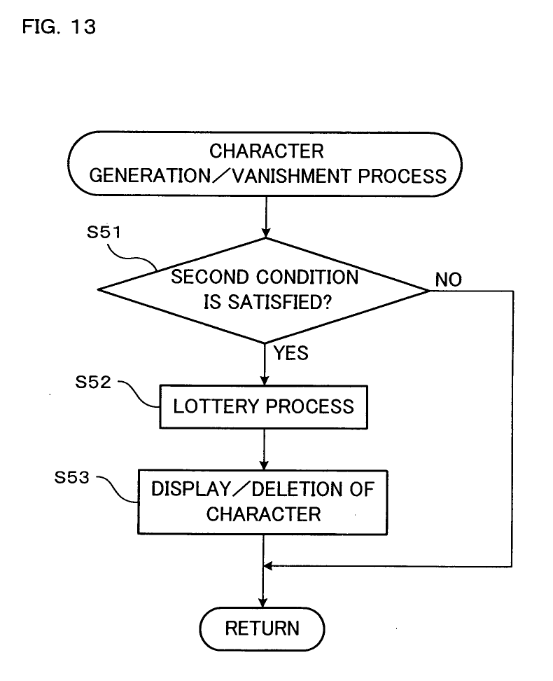

FIG. 13 is a flow chart of a character generation/vanishment process program of the S50. When the main CPU 41 executes the character generation/vanishment process of the S50, it determines whether a second condition is satisfied in the base game, in a S51. Herein, the second condition may include a case where one combination shown in the payout table of FIG. 4 is made in the base game. Herein, when the second condition is satisfied in the base game (S51, YES), the main CPU 41 proceeds to a S52 and carries out a lottery process. In this lottery process, the main CPU 41 extracts a single random number value included in a predetermined numerical range (0 to 255) and determines generation/vanishment/maintenance of the character (hermit crab) 103, from a correspondence relation between the extracted random number value and the character table of FIG. 23. Herein, the maintenance of the character (hermit crab) 103 means that the display of the character (hermit crab) 103 is not changed, i.e., the display of the situation is maintained. After that, the main CPU 41 proceeds to a S53 and carries out the display/deletion of the character (hermit crab) 103.

Specifically, in the S52, when the main CPU 41 extracts any single random number value of “0” to “25”, the main CPU 41 instructs the graphic board 68 to display, in the lower image display panel 6 of the self slot machine, the image that the character (hermit crab) 103 emerges from the sand beach 101 while carrying on the awarding receptacle 104, so as to generate the character (hermit crab) 103. In the mean time, when the character (hermit crab) 103 is already displayed in the lower image display panel 6 of the self slot machine, the main CPU 41 displays a new character (hermit crab) 103 in the lower image display panel 6 of the self slot machine, as described above.

In addition, in the S52, when the main CPU 41 extracts any single random number value of “26” to “30”, the main CPU 41 instructs the graphic board 68 to display, in the lower image display panel 6, the image that the character (hermit crab) 103 is immersed in the sand beach 101 while carrying on the awarding receptacle 104, so as to vanish the character (hermit crab) 103. In the mean time, when a number of characters (hermit crabs) 103 are displayed in the lower image display panel 6 of the self slot machine, the main CPU 41 deletes all the characters (hermit crabs) 103 from the lower image display panel 6 of the self slot machine, as described above. At this time, some of the characters (hermit crabs) 103 may be specified by lot and deleted from the lower image display panel 6 of the self slot machine.

Then, when the main CPU 41 generates/vanishes the character (hermit crab) 103 in the lower image display panel 6 of the self slot machine, the main CPU 41 notifies the signal of the fact of the server 82 via the communication interface 44.

In the mean time, in the S52, when any single random number value of “31” to “255” is extracted, no process is carried out. After that, the main CPU 41 proceeds to a character game value awarding process of a S60 in FIG. 10, including a case where the second condition is not satisfied in the base game (S51, NO).

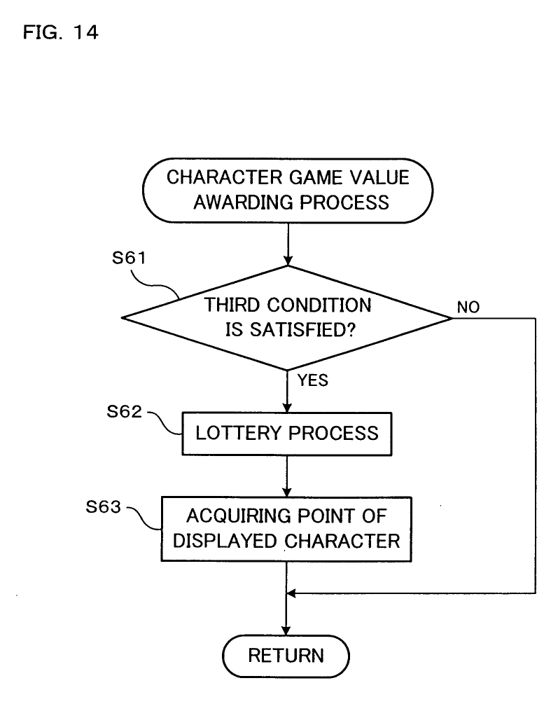

FIG. 14 is a flow chart of a character game value awarding process program of the S60. When the main CPU 41 executes a character game value awarding process of the S60, it determines whether a third condition is satisfied in the base game, in a S61. Herein, the third condition may include a case where “RED 7” is displayed in any one of the display windows 10L, 10C, 10R, as shown in FIG. 20, for example. Herein, when the third condition is satisfied in the base game (S61, YES), the main CPU 41 proceeds to a S62 and carries out a lottery process. In this lottery process, the main CPU 41 extracts a single random number value included in the predetermined numerical range (0 to 255) and determines whether the character (hermit crab) 103 acquires a point (hermit clam) 105, from the correspondence relation between the extracted random number value and a point acquirement table of FIG. 24. After that, the main CPU 41 proceeds to a S63 and carries out a point acquirement process of a character.

Specifically, when the main CPU 41 extracts any single random number value of “0” to “201”, the main CPU 41 instructs the graphic board 68 to display, in the lower image display panel 6 of the self slot machine, the image that the character (hermit crab) 103 finds out a point (clam) 105 from the sand beach 101 and puts it in the own awarding receptacle 104, so as to enable the character (hermit crab) 103 to acquire the point (clam) 105. In the mean time, it is assumed that the number of the points (clams) 105 that the character (hermit crab) 103 puts in the awarding receptacle 104 is the number of the “RED 7” symbols displayed in the display windows 10L, 10C, 10R. However, the invention is not limited thereto. For example, the display number of other symbols, a predetermined number or the number determined by lot may be possible.

Then, when the character (hermit crab) 103 puts the point (clam) 105 in the own awarding receptacle 103 in the lower image display panel 6, the main CPU 41 notifies the signal of the fact of the server 82 via the communication interface 44.

In the mean time, in the S62, when any single random number value of “202” to “255” is extracted, no process is carried out. After that, the main CPU 41 proceeds to a game value accumulation process of a S70 in FIG. 10, including a case where the third condition is not satisfied in the base game (S61, NO).

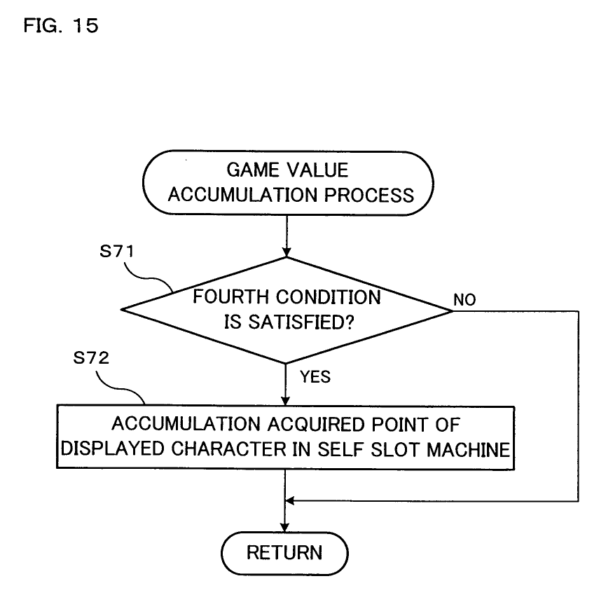

FIG. 15 is a flow chart of a game value accumulation process program of the S70. When the main CPU 41 executes a game value accumulation process of the S70, it first determines whether a fourth condition is satisfied in the base game, in a S71. Herein, the fourth condition may include a case where “BLUE 7” is displayed in any one of the display windows 10L, 10C, 10R, as shown in FIG. 21, for example. Herein, when the fourth condition is satisfied in the base game (S71, YES), the main CPU 41 proceeds to a S72 and instructs the graphic board 68 to display, in the lower image display panel 6 of the self slot machine, the image that the character (hermit crab) 103 moves all the points (clams) 105 to the accumulation receptacle 102 from the own awarding receptacle 104, so as to deposit the acquired points of the displayed character in the self slot machine. Then, when the character (hermit crab) 103 moves all the points (clams) 105 to the accumulation receptacle 102 from the own awarding receptacle 104 in the lower image display panel 6 of the self slot machine, the main CPU 41 notifies a signal of the fact of the server 82 via the communication interface 44. In the mean time, in this embodiment, the character (hermit crab) 103 moves all the points (clams) 105 to the accumulation receptacle 102 from the own awarding receptacle 104. However, the invention is not limited thereto. For example, some of the points determined by lot may be moved. In the mean time, when the point (clam) 105 is not in the awarding receptacle 104 of the character (hermit crab) 103, the display state of the lower image display panel 6 of the self slot machine may be maintained. Alternatively, it may be displayed in the lower image display panel 6 of the self slot machine that the character (hermit crab) 103 notifies that the point (clam) 105 is not in the own awarding receptacle 104. After that, the main CPU 41 proceeds to a game value payout process of a S80 in FIG. 10, including a case where the fourth condition is not satisfied in the base game (S71, NO).

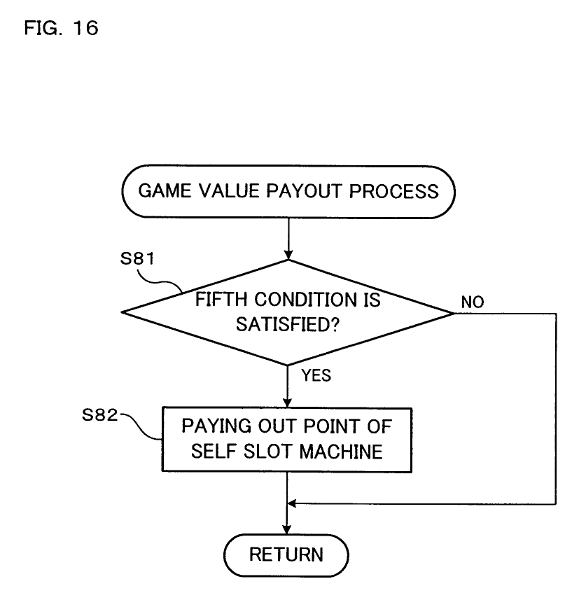

FIG. 16 is a flow chart of a game value payout process program of the S80. When the main CPU 41 executes a game value payout process of the S80, it first determines whether a fifth condition is satisfied in the base game, in a S81. Herein, the fifth condition may include a case where “RED 7” and “BLUE 7” are displayed in the display windows 10L, 10C, 10R, as shown in FIG. 22, for example. Herein, when the fifth condition is satisfied in the base game (S81, YES), the main CPU 41 proceeds to S82, instructs the graphic board 68 to display, in the payout-number display unit 9 of the lower image display panel 6 of the self slot machine, a value obtained by converting all the points (clams) 105 of the accumulation receptacle 102 into payout-number of “10” payouts per point and adding the resultant to the payouts of the base game, so as to payout the deposited points, and deletes all the points (clams) 105 from the accumulation receptacle 102, in exchange of the addition-display. In the mean time, in this embodiment, all the points (clams) 105 are converted into the payout-number of “10” payouts per point and are thus deleted from the accumulation receptacle 102. However, the invention is not limited thereto. For example, some of the points determined by lot may be converted and deleted. In the mean time, when the point (clam) 105 is not in the accumulation receptacle 102, the display state of the lower image display panel 6 may be maintained for example. Alternatively, it may be displayed in the lower image display panel 6 of the self slot machine that the character (hermit crab) 103 notifies that the point (clam) 105 is not in the accumulation receptacle 102. After that, the main CPU 41 proceeds to a character shift compulsion process of a S90 in FIG. 10, including a case where the fifth condition is not satisfied in the base game (S81, NO).

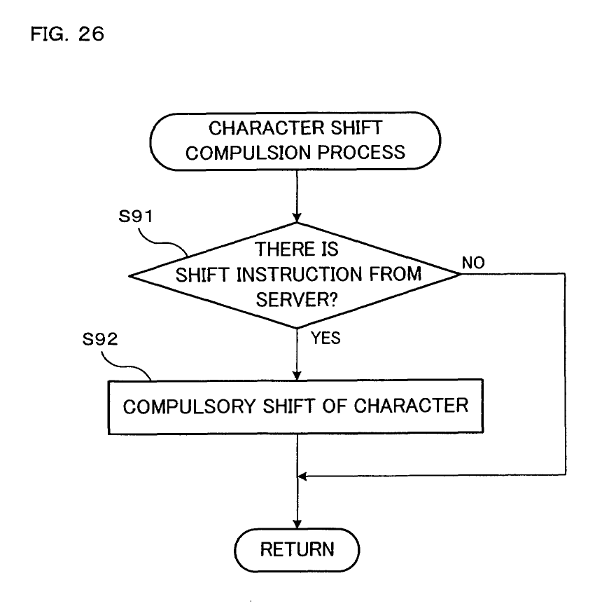

FIG. 26 is a flow chart of a character shift compulsion process program of the S90. When the main CPU 41 executes a character shift compulsion process of the S90, it first determines whether there is a shift instruction from the server 82, in a S91. Herein, when there is a shift instruction from the server 82 (S91, YES), the main CPU 41 proceeds to a S92 and carries out a compulsion shift of the character. Specifically, when it is instructed from the server 82 that the self slot machine is a shift source, the main CPU 41 instructs the graphic board 68 to display an image that the character (hermit crab) 103 displayed in the lower image display panel 6 of the self slot machine is immersed in the sand beach 101 while carrying on the own awarding receptacle 104 (including the existing points (clams) 105, too), thereby deleting the character from the lower image display panel 6 of the self slot machine. In the mean time, when a number of characters (hermit crabs) 103 are displayed in the lower image display panel 6 of the self slot machine, any single character (hermit crab) 103 may be deleted from the lower image display panel 6 of the self slot machine in accordance with the instruction from the server 82, as described above. Alternatively, some or all of the characters (hermit crabs) 103 may be deleted from the lower image display panel 6 of the self slot machine, as described above. In the mean time, when it is instructed from the server 82 that the self slot machine is a shift destination, the main CPU 41 instructs the graphic board 68 to display that the character (hermit crab) 103, which is deleted from the lower image display panel 6 of the shift source, emerges from the sand beach 101 while carrying on the awarding receptacle 104 (including the existing point (calm) 105, too). After that, the main CPU 41 returns to the main game process shown in FIG. 9 through the character link process of FIG. 10, including a case where there is no shift instruction from the server 82 (S91, NO).

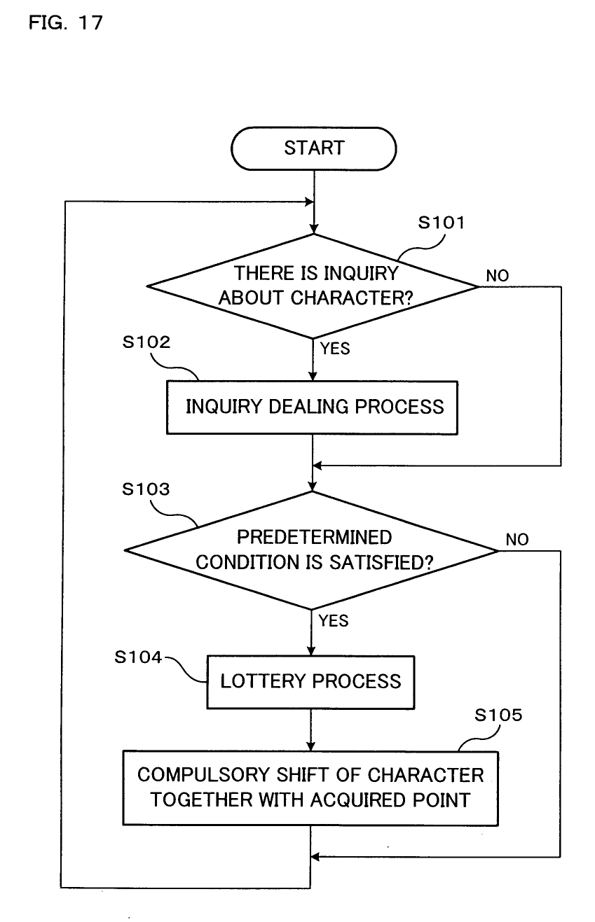

In the mean time, the server 82 as a processor carries out the main game process shown in FIG. 17, so as to execute the character game between the slot machines 1 of the game system 100 according to this embodiment. FIG. 17 is a flow chart of a main game process program in the server 82. When the server 82 executes the main game process, it first determines whether there is an inquiry about the character (hermit crab) 103 from each of the slot machines 1, in a S101. When there is an inquiry about the character (hermit crab) 103 from at least one of the slot machines 1 (S101, YES), the server 82 proceeds to a S202 and carries out an inquiry dealing process. Herein, the inquiry about the character (hermit crab) 103 from each of the slot machines 1 may include the notification of the compulsion return of the character (hermit crab) 103 in the S30, the notification of the generation/vanishment of the character (hermit crab) 103 in the S50, the notification of the acquirement of the point (clam) 105 of the character (hermit crab) 103 in the S60, the notification of the movement of the point (clam) 105 acquired by the character (hermit crab) 103 in the S70 and the like.

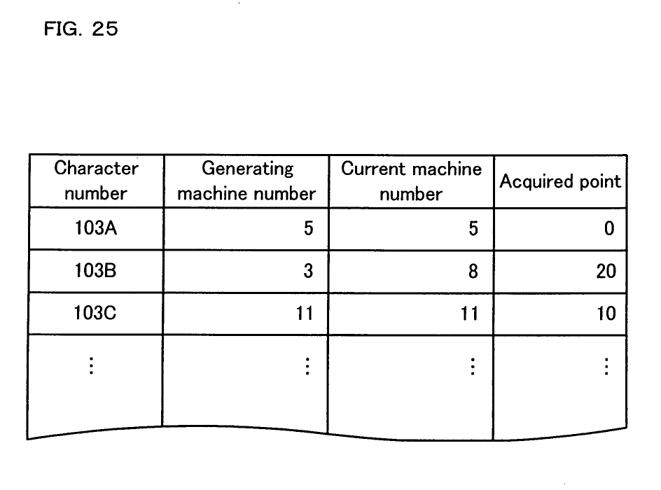

Regarding this, the server 82 uses a character management table shown in FIG. 25 to deal with/reflect the inquiry of the notifications from each of the slot machines 1, thereby managing the character (hermit crab) 103 being generated in the respective slot machines 1. In the mean time, the character management table shown in FIG. 25 includes various fields, such as a character number column in which consecutive numbers are stored which are numbered whenever the character (hermit crab) 103 is generated in the respective slot machines 1, a generating machine number column in which specific numbers of the slot machines 1 having generated the character are stored, a current machine number column in which specific numbers of the slot machines 1 to be currently displayed are stored, an acquirement point column in which the point (clam) 105 put in the awarding receptacle 104 is converted into the payout-number and stored, and the like. Whenever the server 82 receives the notifications from the respective slot machines 1, the server 82 changes the contents of the fields corresponding to the notification contents received, correspondingly to the notification contents. In addition, the server 82 specifies and replies the character (hermit crab) 103, which is a compulsion return object, with respect to the notification of the compulsion return of the character (hermit crab) 103 in the S30.

After that, the server 82 proceeds to a S103, including a case where there is no inquiry about the character (hermit crab) 103 from the respective slot machines 1, and determines whether a predetermined condition is satisfied. This predetermined condition is not completely related to the progress situation of the base game carried out in each slot machine 1 and is determined to be established whenever a predetermined time period elapses. However, the invention is not limited thereto. For example, it may be determined by a lottery result. Herein, when the predetermined condition is satisfied (S103, YES), the server 82 proceeds to a S104 and carries out a lottery process. In the lottery process, the server determines a character (hermit crab) 103 that is a compulsion shift object, based on a character management table shown in FIG. 25. At this time, the server 82 determines the slot machine 1 of a specific number as a shift source, which displays the character (hermit crab) 103 that is a compulsion shift object, and determines the slot machine 1 of a specific number which is a shift destination of the character (hermit crab) 103 that is a compulsion shift object. Herein, the number of the character (hermit crab) 103 that is a compulsion shift object may be plural. After that, the server 82 proceeds to a S105 and notifies the slot machine 1 of the shift source that the slot machine is a shift source and notifies the slot machine 1 of the shift destination that the slot machine is a shift destination. Thereby, the compulsion shift process of the character in the S92 is carried out in the respective slot machines 1 of the shift source and shift destination. In addition, in the S105, the server 82 overwrites the specific number of the slot machine 1 of the shift destination into the current machine number in which the specific number of the slot machine 1 to be currently displayed is stored, for the character management table shown in FIG. 25. After that, the server 82 returns to the S101 to repeat the above processes, including a case where the predetermined condition is not satisfied (S103, NO).

As described above, according to the game system 100 of this embodiment, in each of the two or more slot machines 1 connected to the server 82 via the network (N), the base game is independently carried out in which when any one combination shown in the payout table of FIG. 4 is made, the payout corresponding to the combination made is paid out (S2). At this time, the character return compulsion process (S30), the establishment compulsion process (S40), the character generation/vanishment process (S50), the character game value awarding process (S60), the game value accumulation process (S70), the game value payout process (S80) and the character shift compulsion process (S90), which processes constitute the character link process (S15), are carried out in the respective slot machines 1, so that the character game developed among the respective slot machines 1 is executed to correspond to the progress situation of each base game. The character game is displayed and developed in the lower image display panel 6 of each slot machine 1, as shown in FIGS. 18 to 22. The outline thereof includes a chance as follows: when the character (hermit crab) 103 acquires the point (clam) 105, the character puts the acquired point in the own awarding receptacle 104, when the character (hermit crab) 103 moves the point (clam) 105 to the accumulation receptacle 102 from the awarding receptacle 104, the moved point (clam) 105 is converted into the payout-number and added to the payout of the base game (S82). In addition, when the character (hermit crab) 103 generated in the self slot machine is returned from the other slot machines, the first combination of the base game is compulsorily made and the payout corresponding to the first combination is awarded (S42). In the mean time, the server 82 executes the main game process (S104, S105), so that it determines the slot machine 1 of the shift destination, with respect to the character (hermit crab) 103 and the acquired point (clam) 105 put in the own awarding receptacle 104, although it is not related to the base game carried out in each slot machine 1, and enables the slot machine 1 of the shift destination determined to take over the character and the acquired point (S92).

Thereby, the game system 100 of this embodiment provides the character game that can be developed between the respective slot machines 1 in accordance with the progress situation of the base game carried out in each slot machine 1 linked through the server 82 and the network (N). In the character game, when the character (hermit crab) 103 is shifted to the other slot machines 1, the chance that a new payout is added to the payout of the base game is decreased, or it comes that many new payouts cannot be expected. On the other hand, when the character (hermit crab) 103 is returned to the slot machine 1 having generated it, the chance is increased that the first combination is compulsorily made in the base game or a new payout is added to the payout of the base game, and the player pays attention to the other slot machines 1, so that it is possible to provide a player with a sense of link.

In addition, since the character game is not a combat game, it has no difficulty in separately equipping the two or more slot machines 1, which are connected to the server 82 via the network (N), and the equipment place is not particularly limited.

In the mean time, the invention is not limited to the above embodiment and can be diversely modified without departing the scope of the invention. For example, the first to fifth conditions in the character game may include the return from the bonus game, the operation of the MAX-BET button 17, a prize lot of the bonus game trigger and the like, in addition to the above mentioned conditions.

In addition, when a combination having a high payout is made in the base game, a probability may be increased that the character (hermit crab) 103 displayed in the lower image display panel 6 of the self slot machine will be vanished in the generation/vanishment process of the character of the S50. Furthermore, the contents of the character game may be diversified as follows: the character (hermit crab) 103 being generated may be provided with characteristics such as types, sex and the like; a baby may be borne to the character (hermit crab) 103 being generated when a condition is satisfied in the base game; the baby may be raised in accordance with the development of the base game; the character (hermit crab) 103 may be enabled to speak in a foreign language or to be dressed in foreign clothes when the character is returned to the slot machine 1 having generated it; the other types of point (clam) 105 acquired by the character (hermit crab) 103 may be provided, so that a new bonus game may be carried out or a special payout may be awarded when a predetermined point (clam) 105 is acquired; and when it is continued for a long time the time that the base game is not carried out in the slot machine 1 in which the character (hermit crab) 103 is displayed in the lower image display panel 6 thereof or the time that any combination is not made in the base game, the character (hermit crab) 103 may be made under dormant state. In addition, a person or object may be made as the character.

In addition, the character game may be developed between the base games that are repeatedly carried out in the single slot machine 1.

Furthermore, in this embodiment, the slot machine having the video reels has been exemplified as the gaming machine constituting the game system. However, the invention can be applied to a slot machine having a mechanical reel, a pachi-slot machine, a poker gaming machine and the like.

In addition, with respect to the server 82, any single slot machine 1 connected via the network (N) may act for the server. In this case, the server 82 may be omitted.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A game system comprising a server and two or more gaming machines connected to the server via a network, wherein a game, in which a special benefit is awarded when a predetermined combination is made, is respectively carried out in each of the gaming machines;
each of the gaming machines comprising:
a first lottery unit for determining, by lot, whether a character should be generated or vanished, in accordance with a progress situation of a game;
a display unit for displaying or vanishing the character, based on a lottery result of the first lottery unit;
a game value awarding unit for awarding a game value corresponding to the character, in accordance with the progress situation of the game, when the display unit displays the character;
a game value accumulation unit for picking up and accumulating the game value awarded by the game value awarding unit, in accordance with the progress situation of the game, when the display unit displays the character; and
a game value payout unit for paying out the game value accumulated by the game value accumulation unit, in accordance with the progress situation of the game, when the display unit displays the character,
the server comprising:
a second lottery unit for determining, by lot, a gaming machine of a shift destination, among the gaming machines connected via the network, to which the character is shifted together with the game value awarded about the character, when there exists a gaming machine wherein the character is displayed in the display unit, irrespective of the game carried out in the gaming machine; and
a shift control unit for shifting and displaying the character to the display unit of the gaming machine of the shift destination determined based on a lottery result of the second lottery unit and enabling the gaming machine of the shift destination to take over the game value corresponding to the character.

2. The game system according to claim 1, wherein each of the gaming machines is provided with a return compulsion unit for returning and displaying the character generated in the self gaming machine to the display unit of the self gaming machine in accordance with the progress situation of the game and taking over the game value corresponding to the character.

3. The game system according to claim 1, wherein each of the gaming machines is provided with an establishment compulsion unit for establishing a predetermined combination in the game in progress when the character is shifted and displayed to the display unit of the self gaming machine.

4. The game system according to claim 1, wherein the serve r is one of the gaming machines connected via the network.

5. A game system comprising a server and two or more gaming machines connected to the server via a network, wherein a game, in which a special benefit is awarded when a predetermined combination is made, is independently carried out in each of the gaming machines;
the game system comprising,
a display unit that is provided to each of the gaming machines and displays a character; and
a processor that controls the game,
wherein the processor,
(a) determines, by lot, whether the character should be generated or vanished, in accordance with a progress situation of a game, for each of the gaming machines;
(b) displays or vanishes the character in the display unit, based on the lottery result;
(c) awards a game value corresponding to the character, in accordance with the progress situation of the game, when the display unit displays the character;
(d) picks up and accumulates the game value awarded, in accordance with the progress situation of the game, when the display unit displays the character;
(e) pays out the game value accumulated, in accordance with the progress situation of the game, when the display unit displays the character;
(f) determines, by lot, a gaming machine of a shift destination, among the gaming machines connected via the network, to which the character is shifted together with the game value awarded corresponding to the character, when there exists a gaming machine wherein the character is displayed in the display unit, irrespective of the game carried out in the corresponding gaming machine; and
(g) shifts and displays the character to the display unit of the gaming machine of the shift destination determined based on the lottery result and enabling the gaming machine of the shift destination to take over the game value corresponding to the character.

6. The game system according to claim 5, wherein the processor returns and displays the character, which is generated in the self gaming machine, to the display unit of the self gaming machine and enables the self gaming machine to take over the game value corresponding to the character.

7. The game system according to claim 5, wherein the processor establishes a predetermined combination in the game in progress when the character is shifted and displayed in the display unit of the self gaming machine.

8. The game system according to claim 5, wherein the server is one of the gaming machines connected via the network.

9. A gaming machine connected to a plurality of gaming machines via a network and carrying out a game in which a payout is awarded when a predetermined condition is satisfied, independent of the other gaming machines, the gaming machine comprising:
a display unit that displays the payout; and
a processor that controls the game,
wherein the processor,
(a) displays the payout in the display unit in accordance with a progress situation of a game, and accumulates the payout temporarily;
(b) deletes the payout from the display unit and the payout temporarily accumulated, when the processor receives an instruction signal to shift the payout to the other gaming machine, via the network from the outside, and
(c) transmits an instruction signal to shift and to display the payout to a display unit of the other gaming machine and to enable the other gaming machine to take over the payout temporarily accumulated, to the outside via the network.

10. A gaming machine connected to a plurality of gaming machines via a network and carrying out a game in which a payout is awarded when a predetermined condition is satisfied, independent of the other gaming machines, the gaming machine comprising:
a display unit that displays a character; and
a processor that controls the game,
wherein the processor,
(a) displays the character in the display unit in accordance with a progress situation of a game, and temporarily accumulates a payout corresponding to the character;
(b) deletes the character from the display unit and the payout temporarily accumulated, when the processor receives an instruction signal to shift the character to the other gaming machine together with the payout temporarily accumulated, via the network from the outside, and
(c) transmits an instruction signal to shift and to display the character to a display unit of the other gaming machine and to enable the other gaming machine to take over the payout temporarily accumulated, to the outside via the network.

11. A gaming machine connected to a plurality of gaming machines via a network and carrying out a game in which a payout is awarded when a predetermined condition is satisfied, independent of the other gaming machines, the gaming machine comprising:
a display unit that displays a character; and
a processor that controls the game,
wherein the processor,
(a) displays the character in the display unit in accordance with a progress situation of a game, and awards a payout corresponding to the character;
(b) temporarily accumulates the payout awarded, in accordance with the progress situation of the game,
(c) deletes the character from the display unit and the payout temporarily accumulated, when the processor receives an instruction signal to shift the character to the other gaming machine together with the payout temporarily accumulated, via the network from the outside, and
(d) transmits an instruction signal to shift and to display the character to a display unit of the other gaming machine and to enable the other gaming machine to take over the payout temporarily accumulated, to the outside via the network.

12. A gaming machine connected to a plurality of gaming machines via a network and carrying out a game in which a payout is awarded when a predetermined condition is satisfied, independent of the other gaming machines, the gaming machine comprising:
a display unit that displays a character; and
a processor that controls the game,
wherein the processor,
(a) displays the character in the display unit in accordance with a progress situation of a game,
(b) awards a payout corresponding to the character in accordance with the progress situation of the game;
(c) temporarily accumulates the payout awarded, in accordance with the progress situation of the game,
(d) deletes the character from the display unit and the payout temporarily accumulated, when the processor receives an instruction signal to shift the character to the other gaming machine together with the payout temporarily accumulated, via the network from the outside, and
(e) transmits an instruction signal to shift and to display the character to a display unit of the other gaming machine and to enable the other gaming machine to take over the payout temporarily accumulated, to the outside via the network.
